(19) United States
(12) Patent Application Publication
(10) Pub. No.: US 2009/0050768 A1
(43) Pub. Date: Feb. 26, 2009

(54) Olympic weight plate loading device

(76) Inventor: William Samuel Campbell, (US)

Correspondence Address: WILLIAM SAMUEL CAMPBELL, 10080 ZEPHYR HEIGHTS DRIVE, RENO, NV, 89521, US

(21) Appl. No.: 11/894,273

(22) Filed: Aug. 21, 2007

(51) Int. Cl. B65G 69/28

(52) U.S. Cl. 248/346.01

(57) ABSTRACT

A device used to elevate Olympic Weight plates from the floor that have been placed on an Olympic Barbell, particularly useful with floor-generated exercises such as the Deadlift that require additional plates of the same diameter to be loaded onto the bar as previously loaded plates rest vertical on the floor. The use of the device allows the user to minimize effort in the plate loading process to ensure that optimum strength and energy go towards the designated exercise. This device is manufactured with specific materials so as to provide the user with a sturdy and durable, yet inexpensive piece of exercise assistance equipment which can be used for a multitude of floor-generated Olympic and Powerlifting exercises.

### OBJECTS OF THE INVENTION

It is the object of this invention to provide a practical, efficient, simply constructed and reasonably inexpensive portable piece of exercise assistance equipment that can be used at a home or commercial gym, as well as a high school, college or professional sports weight room.

A further object is to provide an alternative to the expensive, bulky leverage devices currently available for use in lifting an Olympic bar for the loading and unloading of Olympic plates, thus enabling many more users to benefit from the advantage of loading and unloading from an elevated position without having to purchase a large, expensive device.

### BRIEF DESCRIPTION OF THE DRAWING

FIG. 1 is a plan view of the invention.

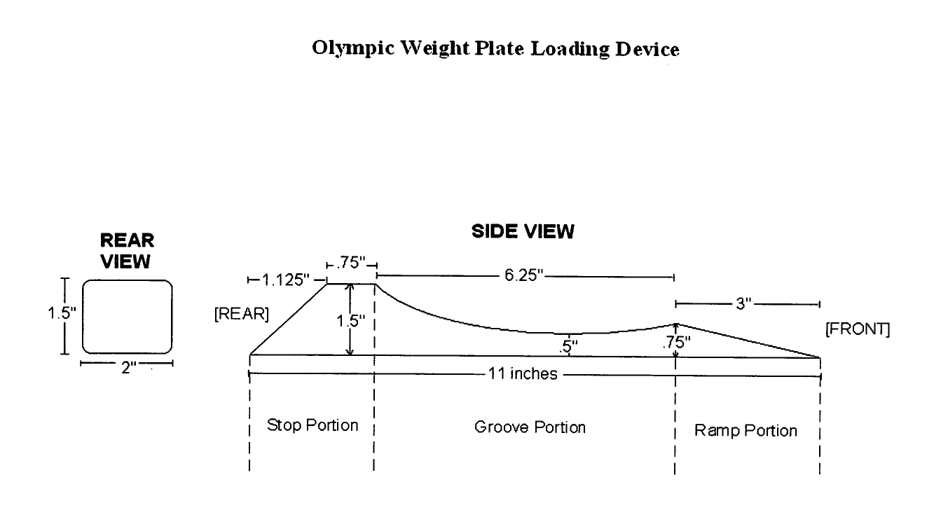

### DETAILED DESCRIPTION OF THE INVENTION

In preferred form, the devise tapers down to the floor making a ramp, allowing a plate currently on the bar to be rolled up onto the device where it rests in the pre-formed “groove” portion that elevates the weight plate(s) up off of the floor. The rear of the device is raised to act as a “stop”, keeping the weight plate secure in the groove portion. Once additional plate(s) are loaded onto the bar, the user rolls the weight plates down the “ramp” portion and back onto the floor. The device is then removed from the exercise area so the user can perform the exercise.

The device measures 11.0 inches in length and 2.0 inches in width. The ramp portion is at the furthest front end of the device and begins flush with the floor as the device lay on the floor in an upright position. The ramp portion measures 3.0 inches from the front and elevates rearward to a height of 0.75 inches. At its highest point, the ramp transitions to the groove portion where a decent to 0.5 inches from the floor is achieved at the groove's lowest point. The groove itself conforms to a circle measuring 17.75 inches in diameter (the diameter of a typical 45 and/or 100 pound Olympic plate). The groove extends to a straight-line measurement of 6.25 inches from the ramp portion to the rear where it ends at a height of 1.5 inches from the floor. Continuing to the rear, the stop portion begins where the groove ends and remains at a height of 1.5 inches for a length of 0.75 inches. The stop portion then slopes down to the floor ending at a length of 1.125 inches from the start of the descent. The device is constructed of either hard rubber or polyurethane and can vary in color.

What is claimed is:

1. A physical fitness exercise equipment device specifically designed to elevate Olympic weight plates, attached to an Olympic barbell, up off of the ground allowing the user to hand load additional plates onto the bar and/or to unload plates off of the bar without having to lift the bar up to create space between the plate and the floor—said device comprising;
A single preformed solid piece of molded material to include a ramp portion, groove portion, and stop portion.

2. The invention described in claim 1 above wherein said preformed solid material is constructed of hard rubber or polyurethane.
